(19) United States
(12) Patent Application Publication
(10) Pub. No.: US 2004/0156748 A1
(43) Pub. Date: Aug. 12, 2004

(54) Chemical analysis apparatus

(76) Inventors: Hironobu Yamakawa, Chiyoda (JP); Hideo Enoki, Chiyoda (JP); Isao Yamazaki, Ryugasaki (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/770,518

(22) Filed: Feb. 4, 2004

(30) Foreign Application Priority Data
Feb. 5, 2003 (JP) 2003-027752

(51) Int. Cl. G01N 35/00

(52) U.S. Cl. 422/64

(57) ABSTRACT

The invention provides a chemical analysis apparatus which can inhibit a solution drop from being scattered and has a high pipetting accuracy. The invention provides a chemical analysis apparatus provided with a reagent vessel, a sample vessel, a reaction vessel to which the reagent and the sample are supplied, a reagent supplying mechanism for supplying the reagent to the reaction vessel, and a sample supplying mechanism for supplying the sample to the reaction vessel, in which at least one of the reagent supplying mechanism and the sample supplying mechanism has a probe portion for sucking and discharging the solution, a probe arm portion communicated with the probe portion and moving the probe portion to the reagent vessel or the sample vessel and the reaction vessel, and a pump to which a pipe is connected, the pipe being communicated with the pump from the probe portion via the probe arm portion, and in which a narrow area having a smaller cross sectional area than a cross sectional area of the pipe in the probe arm portion is provided in the pipe positioned between the probe arm portion and the pump portion.

### BACKGROUND OF THE INVENTION

1. Field of the Invention

The present invention relates to a chemical analysis apparatus which is preferable for analyzing a small amount of material contained in a living body.

2. Description of the Prior Art

An apparatus described in JP-A-2000-121649 is an automatic pipetting apparatus for pipetting a predetermined amount of sample while detecting an abnormality in suction characterized in that the automatic pipetting apparatus has a nozzle means for sucking and discharging the sample on the basis of a change of suction pressure, a pressure detecting means for detecting the suction pressure, a suction pressure curve data calculating means for determining a suction pressure curve data showing a suction pressure changing state from a start of the sample suction until an end of the sample suction, on the basis of a pipetting parameter having an effect on the change of suction pressure, and a suction abnormality detecting means for detecting a suction abnormality on the basis of the suction pressure detected by the pressure detecting means and the suction pressure curve data.

In the prior art mentioned above, although it is taken into consideration that the pressure is changed with time in the course of discharging and sucking a small amount of sample solution or reagent solution, no consideration is given to a transient state in the course of discharging and sucking, and a problem generated momently in a steady state.

First of all, there is no description about a countermeasure against a problem that a water hammer is generated by a rapid movement of a piston (hereinafter, refer to a plunger) within a syringe in an initial operation of a reciprocating motion of the plunger in a transient state at a time of starting the discharge, whereby an accuracy of pipetting is lowered due to a rapid increase and a rapid decrease of the solution measure, or a solution drop is scattered in correspondence to the rapid increase and the rapid decrease of the solution measure, thereby contaminating the apparatus.

Secondly, there is no description about a countermeasure against a problem that the plunger driven by a pulse motor intermittently moves in a steady state in the course of discharging, whereby a pipetting accuracy is lowered by a pressure and a pulsation of the flow rate generated thereby, or the solution drop is scattered, thereby contaminating the apparatus.

Thirdly, there is no description about a countermeasure against a problem that the water hammer is generated in the same manner as that at a time of starting the discharge and the flow rate is rapidly decreased, due to a rapid stop of the plunger in the transient state in the end of the discharge, whereby the pipetting accuracy is lowered due to the solution drop and lack of the pipetting amount, or the solution drop is scattered, thereby contaminating the apparatus.

### BRIEF SUMMARY OF THE INVENTION

Accordingly, an object of the present invention is to provide a chemical analysis apparatus which can contribute to solving at least one of the problems, can inhibit the solution drop from being scattered, and has a high pipetting accuracy.

In order to solve the problem mentioned above, the present invention is characterized in that the following aspects are provided.

(1) There is provided a chemical analysis apparatus comprising:

a reagent vessel provided with a reagent solution;

a sample vessel provided with a sample solution;

a reaction vessel to which the reagent and the sample are supplied;

a reagent supplying mechanism for supplying the reagent to the reaction vessel; and

a sample supplying mechanism for supplying the sample to the reaction vessel,

wherein at least one of the reagent supplying mechanism and the sample supplying mechanism comprises:

a probe portion for sucking and discharging the solution;

a probe arm portion communicated with the probe portion and moving the probe portion to the reagent vessel or the sample vessel and the reaction vessel; and

a pump to which a pipe is connected, the pipe being communicated with the pump from the probe portion via the probe arm portion, and

wherein a narrow area having a smaller cross sectional area than a cross sectional area of the pipe in the probe arm portion is provided in the pipe positioned between the probe arm portion and the pump portion.

(2) There is also provided a chemical analysis apparatus, wherein a high resistance portion having a larger flow path resistance than a flow path resistance of the pipe in the probe arm portion is provided between the probe arm portion and the pump portion.

(3) There is also provided a chemical analysis apparatus, wherein an enlarged area having a larger cross sectional area than a cross sectional area of the pipe in the probe arm portion is provided in the pipe positioned between the probe arm portion and the pump portion.

(4) There is also provided a chemical analysis apparatus, wherein a low rigidity area structured by a material having a rigidity lower than the pipe in the probe arm portion and higher than a silicone resin is provided in the pipe positioned between the probe arm portion and the pump portion.

(5) There is also provided a chemical analysis apparatus, wherein the chemical analysis apparatus comprises:

a first pump to which a pipe is connected, the pipe being communicated with the pump from the probe portion via the probe arm portion; and

a second pump communicated with the pipe in an upstream side of the probe arm portion via a branch portion, and

wherein the first pump has a higher discharge resolving power than the second pump, and the chemical analysis apparatus is controlled in such a manner as to supply a first flow rate of solution from the probe by driving the second pump and supply a second flow rate more than the first flow rate of solution by driving the first pump. There is also provided a chemical analysis apparatus, wherein the chemical analysis apparatus is controlled in such a manner as to start supplying the solution from the probe by the first pump after starting supplying the solution from the probe by the second pump.

In accordance with the aspects shown above, it is possible to provide the chemical analysis apparatus which can contribute to solving at least one of the problems in the prior arts.

In particular, for example, it is possible to provide a chemical analysis apparatus which can make the influence of the water hammer at a time of starting the discharge of the sample and the reagent small, thereby making the pipetting accuracy high and inhibiting the solution drop from being scattered.

It is also possible to provide a chemical analysis apparatus which can make the influence of the pulsation of the pressure and the flow rate in the course of discharging the sample and the reagent small, thereby making the pipetting accuracy high and inhibiting the solution drop from being scattered.

It is also possible to provide a chemical analysis apparatus which can make the influence of the water hammer at the end of discharging the sample and the reagent, thereby making the pipetting accuracy high and inhibiting the solution drop from being scattered.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is a schematic view showing an embodiment in accordance with the present invention;

FIG. 2 is a schematic view showing an embodiment in accordance with the present invention;

FIG. 3 is an explanatory view showing a case of a comparative embodiment;

FIG. 4 is an explanatory view showing a case of a comparative embodiment;

FIG. 5 is an explanatory view showing a case of a comparative embodiment and a case of the present embodiment;

FIG. 6 is a schematic view showing an embodiment in accordance with the present invention;

FIG. 7 is a schematic view showing an embodiment in accordance with the present invention;

FIG. 8 is a schematic view showing an embodiment in accordance with the present invention;

FIG. 9 is an explanatory view showing a case of a comparative embodiment and a case of the present embodiment;

FIG. 10 is an explanatory view showing a case of a comparative embodiment; and

FIG. 11 is a schematic view showing an embodiment in accordance with the present invention.

### DETAILED DESCRIPTION OF THE INVENTION

A description will be given of a first embodiment in accordance with the present invention with reference to the accompanying drawings. In this case, the present invention is not limited to the contents disclosed in the present specification, and does not inhibit modifications on the basis of the current and future well-known matters.

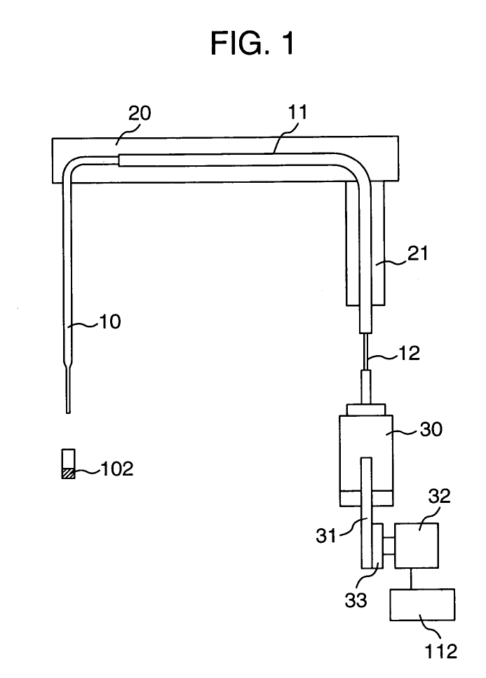

FIG. 1 is a schematic view showing an embodiment in the present chemical analysis apparatus. A probe 10 is fixed to a probe arm 20, and is rotated and vertically moved by an arm rotating rod 21. A pump, for example, a syringe pump 30 is piped to the probe 10 via a tube 11. A resistance portion 12 constituted by a narrow diameter tube is connected to a connection portion between the tube 11 and the syringe pump 30. A system water such as a pure water or the like is filled as a working fluid in the tube. A plunger 31 is moved by a pulse motor 32 via a transmission mechanism 33 such as a belt, a rack and pinion or the like. The pulse motor 32 is controlled by a controller 112. A reagent and a sample pipetted by the probe are discharged to a measurement vessel 102. In the present embodiment, the probe is structured such that an inner diameter is 0.8 mm, an outer diameter is 1.2 mm, a length is 20 cm and a material is SUS having a good chemical resistance, however, is not limited to this. The tube may be constituted by a resin tube in which a good chemical resistance is provided, an inner diameter is 1.5 mm, an outer diameter is 2.3 mm, a length is 2 m and a material is a polyfluoroethylene (a polytetrafluoroethylene). As mentioned above, the resistance portion 12 such as the narrow tube or the like having a smaller cross sectional area than a cross sectional area of the tube 11 in the probe arm 20 portion is provided in the tube 11 corresponding to the pipe positioned between the probe arm 20 and the syringe pump 30.

As mentioned above, since it is possible to obtain an effect that an energy of a pulsation generated in the course of feeding a solution by the pump gets scattered and lost by the resistance portion by arranging the resistance portion mentioned above in the way of the tube, it is possible to lower the pulsation in a discharge port, and it is possible to lower a water hammer and improve a pipetting accuracy.

Further, it is preferable that the narrow pipe is arranged in an upstream side in a piping path from the pump to a leading end of the probe. For example, the following three effects can be obtained by arranging the narrow pipe in an area between the probe arm portion and the pump, whereby it is possible to lower the water hammer and improve the pipetting accuracy.

As a first effect, it is possible to lower the pulsation generated by the syringe pump mentioned above. Since the syringe pump is driven by a pulse motor, the pulsation tends to be generated. The probe arm portion generally employs the resin tube which has a fixed rigidity so as to make the arm be easily driven and is made of the polyfluoroethylene (the polytetrafluoroethylene), however, in the case that a high pressure is applied, the tube is deformed, and enlarges the pulsation generated by the syringe pump. Further, in the case that the tube is deformed, a part of the pressure for sucking and discharging the solution from the probe applied by the syringe pump is consumed for deformation. Accordingly, it is preferable that the pulsation generated by the syringe pump is lowered before being input to the resin tube.

As a second effect, it is possible to lower an influence at a time of resonating due to the pulsation. In the case that a frequency of the pulsation of the syringe pump coincides with a resonance frequency which a fluid system of the present pipetting apparatus from the syringe pump to the probe has in view of its structure, an amplitude of the pulsation is increased. If the placing portion of the resistance portion 12 is at a quarter time distance of the wavelength of the pulsation from the leading end of the probe, it is possible to reduce a magnitude of the amplitude in a discharge port in the leading end of the probe at a time of pulsation. Further, if the placing portion is further closer to the syringe pump, it is possible to inhibit the amplitude in resonance of an entire fluid system. A wavelength of the pulsation can be easily calculated on the basis of an entire length of the pipetting diameter of the fluid system.

As a third effect, it is possible to avoid a problem in manufacturing. In the case of connecting the respective elements comprising the probe, the tube and the syringe pump of the present pipetting system so as to prevent a solution from leaking, it is preferable that the number of the connecting portions is reduced. This is because there is a problem that it is necessary to sufficiently secure a sealing property for preventing the solution from leaking, and there is a problem that the solution is left in view of the general structure of the connection portion. Accordingly, it is hard in view of manufacturing that the connection portion is provided in the way of the tube. In the same manner, in the case of placing the connection portion in front of the probe, there is generated a problem. Because there is a case that the solution enters into the tube from the probe due to an increase of the suction amount. In other words, in the case that the resistance portion is provided in front of the probe, the sucked solution passes through only the connection portion between the probe and the tube conventionally, however, in the case that the resistance portion is arranged in front of the probe, the solution passes through totally two connection portions among the probe, the resistance portion and the tube, so that the solution tends to be left.

Further, in the case that the resistance portion 12 is provided with the narrow pipe, it is preferable that a cross sectional area of the pipe is equal to or less than 99/100 a cross sectional area of the tube 11 in the probe arm 20, and a length of the pipe is equal to or less than ⅕ a length of the tube 11 in the probe arm 20. Since the fluid passes through such a level of narrow pipe, a flow is changed in the connection portion between the tube 11 of the probe arm 20 portion and the narrow pipe and the resistance is generated, so that it is possible to provide an effect that the energy of the pulsation is scattered and lost. In the case that it is necessary to widen a movable range of the tube for convenience of mounting on the apparatus, it is possible to inhibit the tube including the connection portion and the narrow portion from being excessively deformed due to a different diameter, and it is possible to prevent the resonance with the pulsation from being generated, by at least setting an area ratio equal to or less than ⅘ and setting a length ratio equal to or less than 1/10.

Further, when the pipe becomes narrow, a pressure loss is increased, so that there is a risk that a static pressure of the fluid becomes equal to or less than a saturated vapor pressure and a cavitation is generated so as to lower the pipetting accuracy. Since the static pressure of the fluid is determined in accordance with the flow rate and the shape of the fluid system, the static pressure is different in correspondence to the apparatus, however, it is preferable that the cross sectional area of the narrow pipe is equal to or more than 1/100 the cross sectional area of the tube 11, and the length of the narrow pipe is equal to or more than 1/1000 the length of the tube 11. Accordingly, it is possible to prevent the pressure loss from being increased more than necessary. In the case that it is necessary to suck and discharge the fluid at a very high pressure in order to increase a pipetting speed for convenience of the apparatus, there is a possibility that the pressure loss is generated further in the portion in which the cross sectional area is changed, however, if the cross sectional area ratio is equal to or more than ⅕ and the length ratio is equal to or more than 1/500, it is possible to change the flow of the connection portion, and it is possible to obtain a certain degree of effect which is not sufficient.

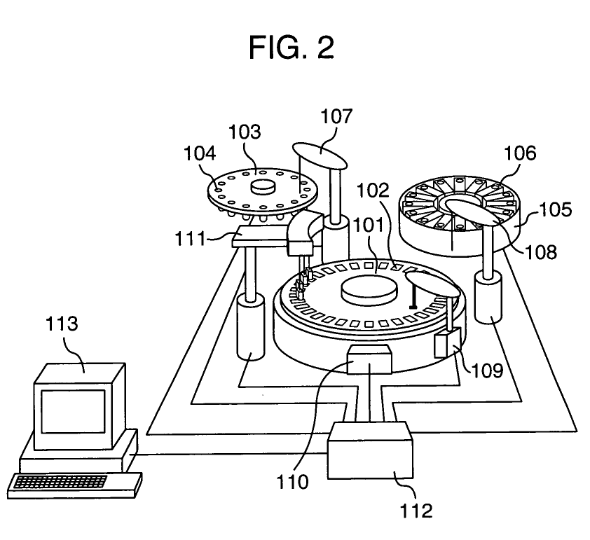

FIG. 2 is a general schematic view showing a structure of a chemical analysis apparatus in accordance with the present embodiment. The present chemical analysis apparatus is provided, for example, with a plurality of reaction vessels 102 each having an upper opening portion, pipetting mechanisms 107 and 108 corresponding to a supplying mechanism for supplying a sample and a reagent from the opening portion, and a photometric mechanism 110 corresponding to a measuring means for measuring physical properties of the sample which is under reaction or finishes the reaction. A description will be given of this chemical analysis apparatus.

In particular, the chemical analysis apparatus is constituted by a reaction disc 101 for mainly storing the reaction vessel 102, a constant temperature bath 114 for keeping a constant temperature state of the reaction vessel stored in the reaction disc 101, a sample turn table 103 for receiving a sample vessel 104, a reagent turn table 105 for storing a reagent bottle 106, the sampling pipetting mechanism 107 for pipetting the sample and the reagent to the respective reaction vessels, the reagent pipetting mechanism 108, an agitating mechanism 109 for agitating the pipetted sample and reagent within the reaction vessel, the photometric mechanism 110 for measuring an absorbance in the process of reaction of the mixed materials within the reaction vessel and after the reaction, and a cleaning mechanism 111 for cleaning the reaction vessel after the test (the photometry) is finished. Each of the constituting elements is operated in accordance with a program automatically prepared by a controller 112 on the basis of an information (analysis items and volume to be analyzed) which is previously set by a console 113 before starting the test.

In the structure mentioned above, a description will be given of an embodiment of an operation of the present chemical analysis apparatus.

The probe arm 20 and the probe arm 21 execute a rotational motion and a vertical motion, whereby the probe 10 is dipped into the sample cup 104 in which the sample is contained and the reagent bottle 106 in which the reagent is contained, and thereafter the plunger 31 is moved downward by the controller 112, and sucks the sample into the probe 10. Successively, the probe arm 20 and the probe arm 21 again execute the rotational motion and the vertical motion so as to move to the above of the reaction vessel 102, and thereafter the plunger 31 is moved upward and discharges the sample and the reagent within the probe into the reaction vessel 102.

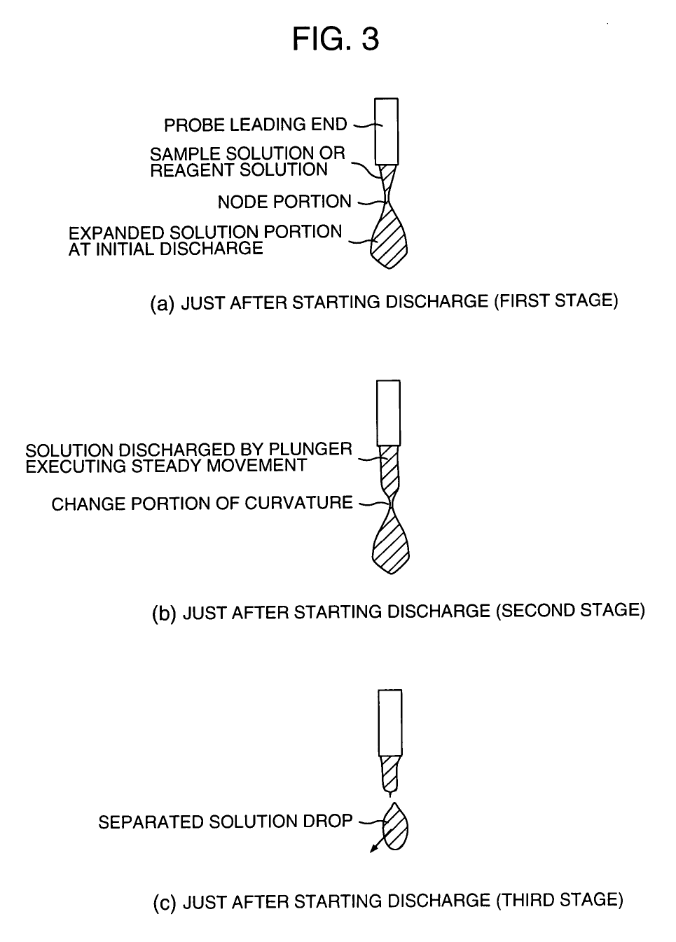

Accordingly, in the discharging mechanism constituted by the probe, the tube and the syringe pump in the chemical analysis apparatus, it is possible to inhibit the problem which is generated in the transient state at a time of starting the discharge. In other words, the plunger rapidly moves in an initial operation for discharging in the plunger, whereby a water hammer is generated. As shown in FIG. 3, as a first stage, there is a case that when a high pressure small amount of solution within the probe is rapidly exposed to the atmosphere by an impact force of the water hammer, the small amount of solution is not discharged due to a strong surface tension in a resting state of the small amount of solution at a leading end of the probe even by being fed at the high pressure, so that the volume of the solution is rapidly increased. At this time, a capacity of the discharged solution is rapidly increased by the water hammer in an initial value, and it is impossible to faithfully reflect a volume change in accordance with the movement of the plunger. Accordingly, it is possible to inhibit the pipetting accuracy from being lowered, by employing the present embodiment.

As the next stage, since an overshoot of the pressure is generated during the time when the volume of the solution is rapidly increased in the leading end of the probe, the pressure is rapidly lowered as a “returning phenomenon” thereof, and the amount of the solution fed at that time is lowered. Accordingly, a diameter of the discharged solution at the leading end of the plunger becomes narrow like a node, a solution break is generated in some cases, and it is possible to inhibit the broken solution drop from being scattered to the periphery. Further, at this time, since the capacity of the discharged solution is rapidly reduced in the “returning”, it is possible to inhibit the pipetting accuracy from being lowered due to the matter that the volume change caused by the movement of the plunger is not faithfully reflected.

Further, in the case that the solution is scattered to the other portions than the measurement vessel, the discharged solution is reduced, so that it is possible to inhibit the pipetting accuracy from being lowered and it is possible to inhibit the broken solution from being scattered to the periphery so as to contaminate the apparatus.

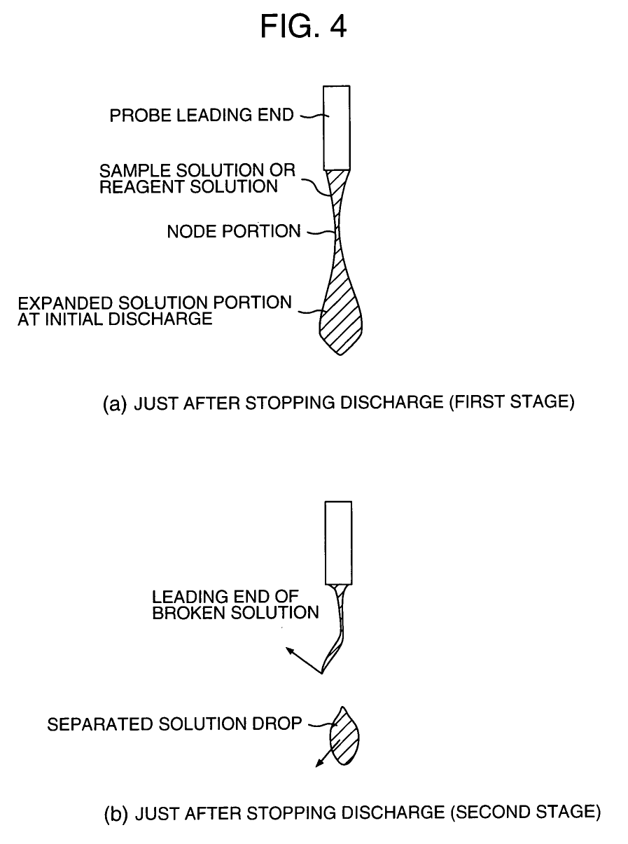

Further, in the discharge mechanism constituted by the probe, the tube and the syringe pump in the chemical analysis apparatus which does not employ the aspect in accordance with the present embodiment, since the plunger suddenly stops in the transient state at the end of the discharge, the pressure is rapidly lowered, so that there is a case that the flow rate is lowered. At this time, since the narrow diameter node portion is generated in the discharged solution as shown in FIG. 4, the solution break is generated, and there is a risk that the broken solution drop is scattered to the periphery. Further, since the solution close to the broken node rapidly loses a binding power, the solution executes an unstable motion, and the solution goes around the leading end of the probe in some cases so as to be attached thereto. Since the probe moves while executing the vertical motion and the rotational motion after being discharged, there is a risk that the solution attached at this time is scattered together with the movement of the probe. Further, there is a case that the solution stays in a state of protruding from the leading end on the basis of the surface tension while the solution does not go around an outer side of the probe, however, in this case, there is a possibility that the protruding solution is scattered together with the movement of the probe. It is possible to structure the analysis apparatus inhibiting the possibility mentioned above, by employing the present embodiment. Further, since the portion in which the solution break is generated depends greatly upon physical properties such as a viscosity, a wettability and the like contained in the discharged sample or reagent, the portion changed every discharging time, however, the present embodiment can inhibit the risk that the pipetting accuracy is lowered due to the change of the discharging amount.

A problem generated at a time of starting the discharge and finishing the discharge is further increased at a time of intending to make the pipetting speed high. Accordingly, the present embodiment is preferable for structuring an analysis apparatus provided with a mechanism of pipetting at a high speed. For example, when discharging at a high speed, the water hammer caused by the rapid stop of the plunger is further enlarged, a possibility that the solution is scattered due to the solution break is higher, and there is a problem that the pipetting accuracy is greatly lowered.

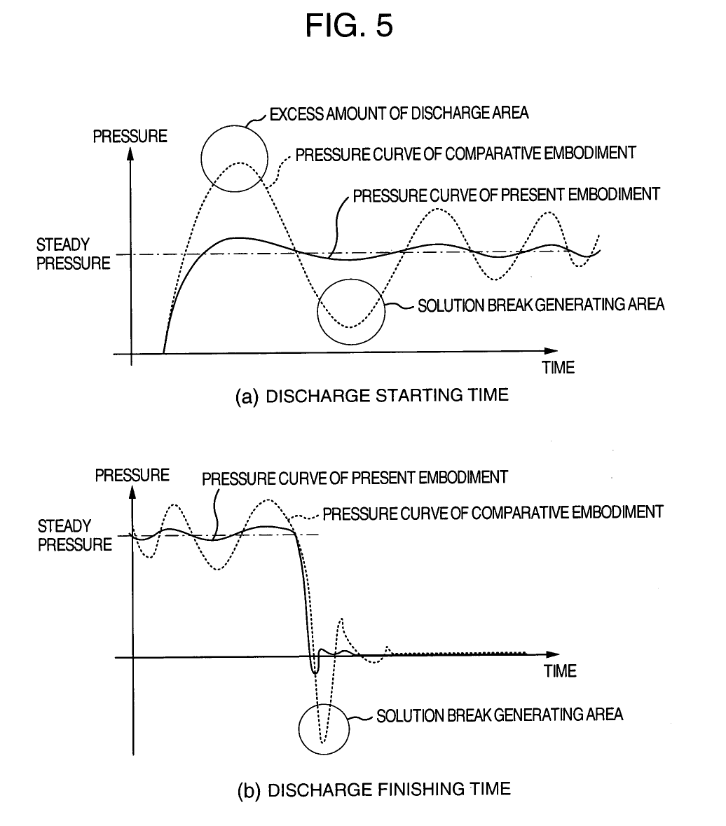

A transient pressure fluctuation at this time is shown by FIGS. 5A and 5B. The case in accordance with a comparative embodiment which does not employ the present embodiment is shown by a broken line, and the case using the structure shown by the present embodiment is shown by a solid line. At this time, the pressure shows a water hammer phenomenon such as an overshoot and a “returning” thereof as illustrated, the solution is discharged at an excessive amount as mentioned in the problem to be solved by the invention, and a problem such as a solution break or the like is further generated.

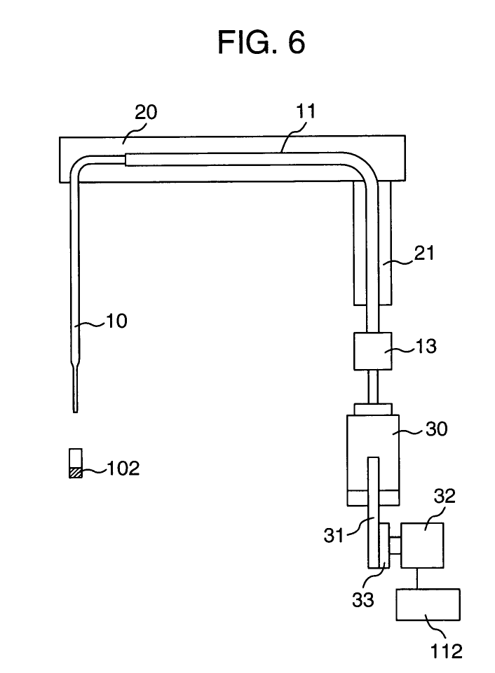

In the present embodiment, even in the case that it is intended to reduce a change by using standard products for the probe and the tube, the portion generating the fluid resistance can be concentrated to a portion near the syringe pump corresponding to a pressure source. In this case, it is conceivable to employ a method of placing an orifice, however, an aspect of easily inserting the narrow pipe is desirable. In the present embodiment, the narrow pipe having the length 10 mm and the inner diameter 1 mm is inserted. Since the inner diameter is within a limit of the cross sectional area with respect to the other tube diameter 1.5 mm such as the probe arm 20, a wave form of the pressure is as shown by the solid lines in FIGS. 5A and 5B, the influence of the water hammer such as the overshoot and the “returning” thereof breaks down, it is possible to inhibit the discharge at the excessive amount, and the solution break is hard to be generated. Further, another embodiment is shown in FIG. 6. The embodiment in FIG. 6 can basically have the same structure as that in FIG. 1 mentioned above, however, the embodiment in FIG. 6 is characterized in that an expanded area having a larger cross sectional area than the cross sectional area of the tube 11 in the probe arm 20 is provided in a pipe positioned between the probe arm 20 and the syringe pump 30, in place of the resistance portion 12 mentioned above. A pipe having an inner diameter about 5 mm and a length about 10 mm can be connected as a volumetric capacity portion having a fixed capacity and arranged in a connection portion of the tube to the syringe pump, however, the structure is not limited to this.

In particular, it is advisable that the cross sectional area of the volumetric capacity portion corresponding to the expanded area is equal to or more than 101/100 times the cross sectional area of the tube 11 in the probe arm 20 and 1/1000 times the length, and it is preferable that the cross sectional area is equal to or more than 5/4 times, and the length is equal to or more than 1/500 times. This is because the capacity is a minimum capacity which can absorb a vibration energy contained in the fluid and can be scattered and lost. Further, for example, as an upper limit, it is preferable that the cross sectional area is equal to or less than 10 times and the length is equal to or less than ⅕, and the cross sectional area is equal to or less than twice and the length is equal to or less than 1/10, for the purpose of preventing the pressure fluctuation from being propagated into the volumetric capacity portion from the syringe pump so as to lower a response of the fluid system. Accordingly, it is possible to save an amount of the pure water consumed in the fluid system. It is desirable that the installation position is at a distance ¼ times the wavelength of the pulsation from the leading end of the probe, and near the syringe portion.

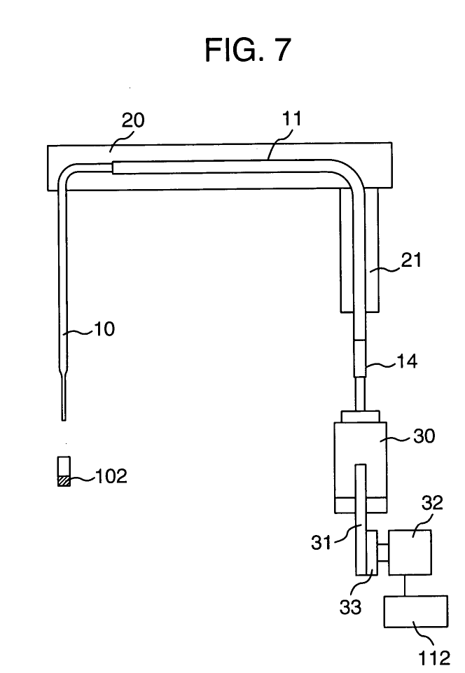

The other embodiment is shown in FIG. 7. The embodiment in FIG. 7 can basically have the same structure as that in FIG. 1 mentioned above, however, the embodiment in FIG. 7 is characterized in that an elastic portion 14 is provided in a pipe positioned between the probe arm 20 and the syringe pump 30, in place of the resistance portion 12 and the volumetric capacity portion 13 mentioned above. In particular, it is preferable that an elastic area structured by a material having a lower elastic modulus in tension than the probe and having a rigidity in a range of the elastic modulus in tension between 100 and 3000 kgf/cm² is provided in the pipe positioned between the probe arm portion and the pump portion.

As the elastic portion 14, it is desirable to insert an elastic pipe constituted by a resin tube having a rigidity in a range of the elastic modulus in tension between 100 and 3000 kgf/cm². For example, it is preferable to insert a tigon tube having an elastic modulus of tension 160 kgf/cm² and a length about 50 mm. The tube 11 is a resin tube having a comparatively high elastic modulus of tension about 3500 kgf/cm² such as a polyfluoroethylene (polytetrafluoroethylene) tube or the like. The water hammer of the syringe pump and the energy of the pulsation are propagated as it is to the leading end of the probe, and the pipetting solution tends to be discharged at an excess amount and the solution break tends to be generated. Accordingly, by inserting the elastic pipe having the elastic modulus in tension equal to or less than 3000 kgf/cm², the elastic pipe is deformed at a time when the pressure is propagated to the inserted elastic pipe, so that it is possible to obtain an effect that the water hammer and the pressure of the pulsation can be consumed by the deformation of the elastic pipe. Further, as a lower limit of the elastic modulus of the elastic pipe, for example, in the case of a resin tube such as a silicon tube or the like having a comparatively low rigidity in which the elastic modulus in tension is about 60 kgf/cm², a great deformation such as a flat shape of the tube is generated in the case that a high pressure is applied at a time of discharging. In the extreme case, the tube is collapsed and the fluid can not flow. Accordingly, it is desirable that the elastic modulus in tension is equal to or more than 100 kgf/cm².

In this case, it is preferable that the elastic area includes a position at a distance ¼ times the pulsation from the leading end of the probe or integral multiple areas.

Since it is possible to obtain the effect that the energy of the pulsation generated in the solution is scattered and lost, it is possible to lower the pulsation in the discharge port, and it is possible to lower the water hammer and improve the pipetting accuracy. As mentioned above, since the influence of the water hammer is reduced at a time of starting the discharge by arranging the fluid resistance portion in the course of the narrow pipe connecting the probe and the syringe pump, in particular, near the connection portion between the syringe pump and the narrow pipe, it is possible to provide the chemical analysis apparatus in which the pipetting accuracy is high and the sample and the reagent are not scattered.

Further, since the influence of the water hammer is reduced at a time of finishing the discharge by arranging the fixed volumetric capacity portion in the course of the narrow pipe connecting the probe and the syringe pump, in particular, near the connection portion between the syringe pump and the narrow pipe, it is possible to provide the chemical analysis apparatus in which the pipetting accuracy is high and the sample and the reagent are not scattered.

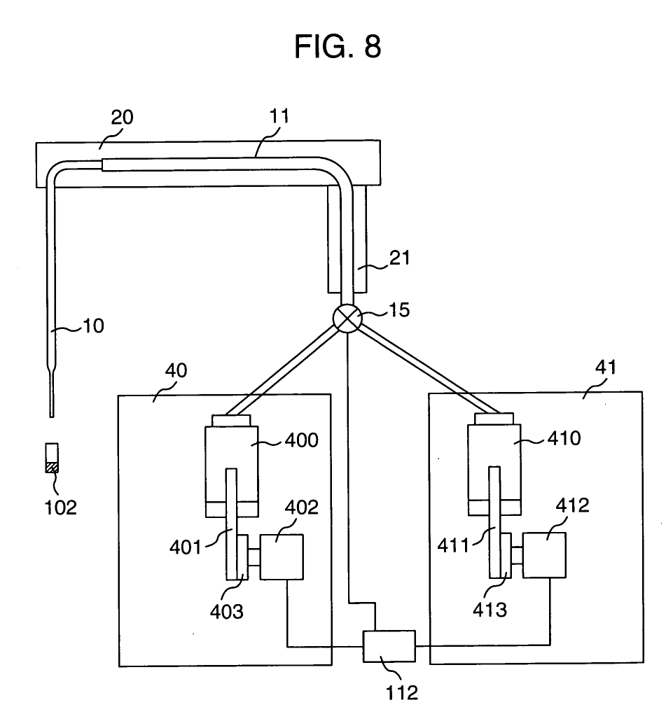

Further, since the influence of the water hammer is reduced at a time of finishing the discharge by arranging the fixed elastic portion in the course of the narrow pipe connecting the probe and the syringe pump, in particular, near the connection portion between the syringe pump and the narrow pipe, it is possible to provide the chemical analysis apparatus in which the pipetting accuracy is high and the sample and the reagent are not scattered. The other embodiment is shown in FIG. 8. FIG. 8 is a schematic view showing an embodiment in the present chemical analysis apparatus. The probe 10 is fixed to the probe arm 20, and is rotated and vertically moved by the arm rotating rod 21. A high resolving power syringe pump portion 40 and a low resolving power syringe pump portion 41 are piped to the tube 11 via a valve 14 controlled by a controller 112. In the high resolving power syringe pump portion 40, a plunger 401 is moved by a pulse motor 402 via a transmission mechanism 403 such as a belt, a rack and pinion and the like. The pulse motor 402 is controlled by the controller 112. In the low resolving power syringe pump portion 41, a plunger 411 is moved by a pulse motor 412 via a transmission mechanism 413 such as a belt, a rack and pinion and the like. The pulse motor 412 is controlled by the controller 112. As the syringe pump having a high resolving power listed here, there is listed up a pencil type pump having a small discharge resolving power 0.02 uL/P and manufactured by Uniflows Co., Ltd, and the like, however, the syringe pump is not limited to this. As the low resolving power syringe pump, the syringe pump having the resolving power about 0.1 uL/P can be used. A pump, for example, a syringe pump 30 is piped to the probe 10 via the tube 11. The resistance portion 12 constituted by a narrow diameter pipe is connected to the connection portion between the tube 11 and the syringe pump 30. A system water such as a pure water or the like is filled in the tube.

As mentioned above, the structure in accordance with the present embodiment is provided with the syringe pump 40 corresponding to the high resolving power first pump which is communicated with the probe 10 via the tube 11 formed in the probe arm 20, and on the other hand is provided with the syringe pump 41 corresponding to the low resolving power second pump via a changing valve 14 corresponding to a branch portion. Further, these pumps are selectively used in correspondence to the discharge flow rate from the probe 10. In particular, for example, a control is executed in such a manner as to discharge a first flow rate of solution from the probe 10 by driving the syringe pump 41, and to discharge a second flow rate more than the first flow rate of solution by driving the syringe pump 40.

A description will be given in particular of an embodiment of an operation of the present chemical analysis apparatus in accordance with the present embodiment.

A basic operation that the reagent and the sample are sucked and discharged by the probe 10 is the same as that shown in the first embodiment. In the case that a small flow rate is required such as the case that the pipetting amount is small, the high resolving power syringe pump 40 is used. In the case that a large flow rate is required such as the case that the pipetting amount is large, the low resolving power syringe pump 41 is used. These two syringe pumps are switched by the valve 15.

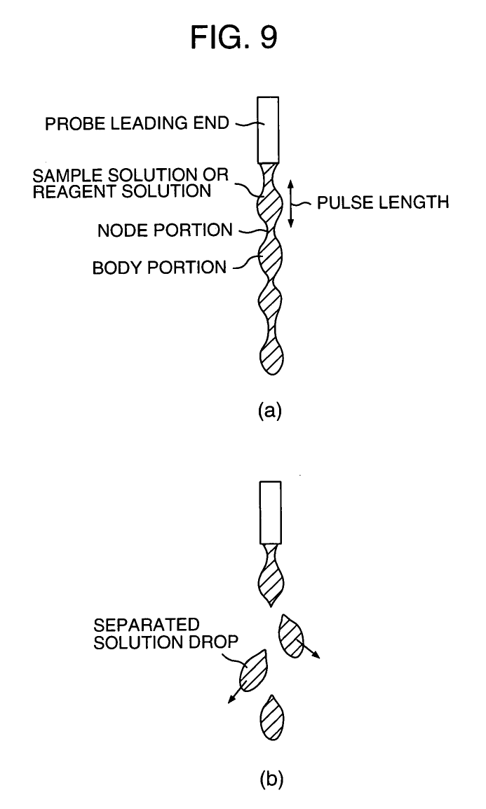

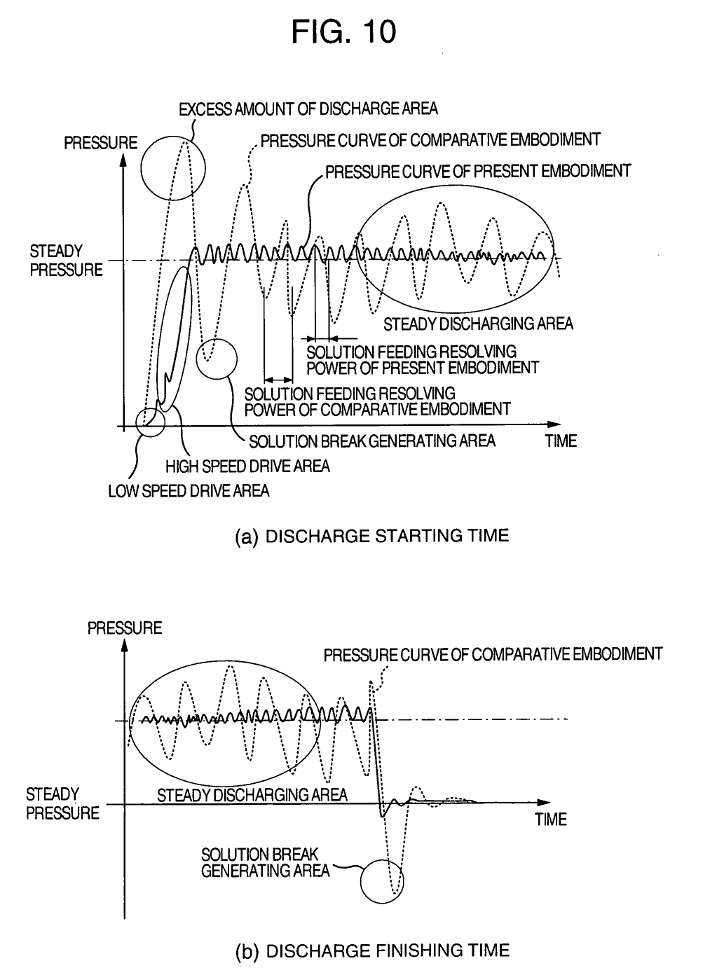

The high resolving power syringe pump is driven at a low speed at a time of starting, and is driven at a high speed after a certain time has passed. A transient pressure fluctuation at this time is as shown in FIG. 9. A case that the low resolving power syringe pump is used in the case that the flow rate is small is shown as a comparative embodiment by a broken line, and a case that the high resolving power syringe pump shown in the present embodiment is used is shown by a solid line. In the case of using the low resolving power syringe pump, the discharging amount per one pulse is large. Accordingly, even when driving the low resolving power syringe pump at a low speed, a high flow rate is generated, and the solution is discharged at an excess amount as the water hammer phenomenon, and the pressure at this time indicates an overshoot as in a broken line in FIG. 10. However, since the discharging amount per one pulse becomes small by using the high resolving power syringe pump, the solution can be actually fed at a low flow rate by driving the high resolving syringe pump at a low speed, and it can be known as shown in a solid line in FIG. 10 that the overshoot is inhibited. Further, it is possible to inhibit the rapid lowering of the pressure which generates the solution break caused by the “returning phenomenon” from the overshoot.

Further, the inventors of the present application have made a study on a countermeasure against the pulsation of the pressure and the flow rate which are generated due to the change in pulse of the discharging pressure, in a steady state in the way of discharging. The inventors of the present application have found that in the case that the pulsation is generated, a node portion and a body portion are generated in the sample and the reagent which are discharged from the probe, in the same manner as the case that the water hammer is generated at a time of starting the discharge, as shown in FIG. 9, the solution break tends to be generated in a boundary portion between the node portion and the body portion in which a curvature is changed, and the broken solution is scattered to the periphery, whereby there is a risk that the broken solution contaminate the apparatus. Further, the inventors of the present application have found that in the case that the solution is scattered to the other portions than the measurement vessel, the discharged solution is reduced, whereby there is a risk that the pipetting accuracy is lowered.

Alternatively, it is preferable that the control is executed in such a manner that the supply of the solution from the probe 10 is started by the pump having the low discharge resolving power, after starting the discharge of the solution from the probe 10 by the pump having the high discharge resolving power. For example, the pump having the high discharge resolving power is driven for the initial operation of the solution discharge from the probe 10, and thereafter, the operation is switched to the pump having the low discharge resolving power. Alternatively, it is preferable that the solution is discharged by again switching to the pump having the high discharge resolving power at the end of the solution discharge, after the operation by the pump having the low discharge resolving power. In the case that the pump is switched in the steady state in the course of the discharge as in the present embodiment, it is possible to inhibit the large pulsation which is generated due to the low resolving power. Accordingly, a length between the node portion and the body portion formed in the sample or the reagent discharged from the probe, a so-called pulse length becomes short, and the break between the node portion and the body portion is hard to be distinguished, whereby it is possible to make the solution break hard to be generated.

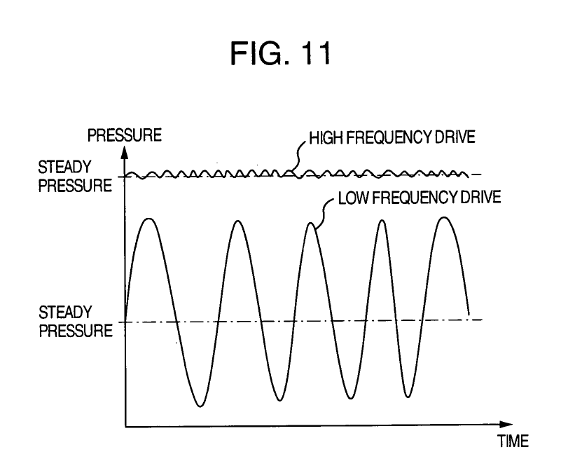

In general, in the high resolving power syringe pump driven by the pulse motor, in the case that a driving frequency of the pulse motor is increased for increasing the flow rate, there is a risk that the motor can not follow the driving frequency and becomes inoperative, whereby the discharge can not be executed. Therefore, an entire efficiency can be improved by changing the valve in the case of the high flow rate ad using the low resolving power syringe pump, as in the present embodiment. FIG. 11 shows wave forms of the discharge pressure in the steady state, in the case that the low resolving power pump is driven at the high flow rate, that is, the high frequency, and in the case that the low resolving power pump is driven at the low flow rate, that is, the low frequency. The low resolving power syringe pump is driven at the low frequency by the pulse motor. However, at this time, even when the plunger is moved by one pulse, the flow rate is increased and the pressure is increased, a pulse interval up to the next applied pulse is long, whereby the flow rate is lowered and the pressure is lowered. Therefore, the vibration of the pressure is increased. However, in the case of employing the high frequency, since the next pulse is applied before the flow rate is sufficiently lowered due to the short pulse interval, the vibration of the pressure is lowered. Accordingly, the solution break is hard to be generated.

As mentioned above, since the influence of the water hammer at a time of starting the discharge can be made small even when starting the discharge, by feeding the solution by the high resolving power syringe pump in the case of the low flow rate, it is possible to provide the chemical analysis apparatus in which the pipetting accuracy is high and the sample and the reagent are not scattered.

Further, since the solution is fed by the high resolving power syringe pump in the case of the low flow rate, and the solution is thereafter fed by the low resolving power syringe pump, it is possible to make the pulsation of the pressure and the flow rate in the steady state in the course of the discharging smaller. Accordingly, it is possible to provide the chemical analysis apparatus in which the pipetting accuracy is high and the sample and the reagent are not scattered.

Further, since the influence of the water hammer at a time of finishing the discharge can be made small, by feeding the solution by the high resolving power syringe pump in the case of the low flow rate, it is possible to provide the chemical analysis apparatus in which the pipetting accuracy is high and the sample and the reagent are not scattered.

Further, since the influence of the water hammer at a time of finishing the discharge can be made small, by operating the high resolving power syringe pump slowly in the initial operation and the end operation in the case of the low flow rate, it is possible to provide the chemical analysis apparatus in which the pipetting accuracy is high and the sample and the reagent are not scattered.

Further, since the low resolving power syringe pump is operated in the case of the large flow rate by switching the valve, and it is possible to make the pulsation of the pressure and the flow rate in the steady state in the course of the discharging smaller at this time, it is possible to provide the chemical analysis apparatus in which the pipetting accuracy is high and the sample and the reagent are not scattered.

In accordance with the present invention, it is possible to provide the chemical analysis apparatus which can contribute to solving at least one of the problems in the prior art, can inhibit the solution drop from being scattered and has the high pipetting accuracy.

It should be further understood by those skilled in the art that the foregoing description has been made on embodiments of the invention and that various changes and modifications may be made in the invention without departing from the spirit of the invention and the scope of the appended claims.

1. A chemical analysis apparatus comprising:
a reagent vessel provided with a reagent solution;
a sample vessel provided with a sample solution;
a reaction vessel to which said reagent and said sample are supplied;
a reagent supplying mechanism for supplying said reagent to said reaction vessel; and
a sample supplying mechanism for supplying said sample to said reaction vessel,
wherein at least one of said reagent supplying mechanism and said sample supplying mechanism comprises:
a probe portion for sucking and discharging the solution;
a probe arm portion communicated with said probe portion and moving said probe portion to said reagent vessel or said sample vessel and said reaction vessel; and
a pump to which a pipe is connected, said pipe being communicated with the pump from said probe portion via said probe arm portion, and
wherein a narrow area having a smaller cross sectional area than a cross sectional area of said pipe in said probe arm portion is provided in said pipe positioned between said probe arm portion and said pump portion.

2. A chemical analysis apparatus comprising:
a reagent vessel provided with a reagent solution;
a sample vessel provided with a sample solution;
a reaction vessel to which said reagent and said sample are supplied;
a reagent supplying mechanism for supplying said reagent to said reaction vessel; and
a sample supplying mechanism for supplying said sample to said reaction vessel,
wherein at least one of said reagent supplying mechanism and said sample supplying mechanism comprises:
a probe portion for sucking and discharging the solution;
a probe arm portion communicated with said probe portion and moving said probe portion to said reagent vessel or said sample vessel and said reaction vessel; and
a pump to which a pipe is connected, said pipe being arranged from said probe portion via said probe arm portion, and
wherein a high resistance portion having a larger flow path resistance than a flow path resistance of said pipe in said probe arm portion is provided between said probe arm portion and said pump portion.

3. A chemical analysis apparatus comprising:
a reagent vessel provided with a reagent solution;
a sample vessel provided with a sample solution;
a reaction vessel to which said reagent and said sample are supplied;
a reagent supplying mechanism for supplying said reagent to said reaction vessel; and
a sample supplying mechanism for supplying said sample to said reaction vessel,
wherein at least one of said reagent supplying mechanism and said sample supplying mechanism comprises:
a probe portion for sucking and discharging the solution;
a probe arm portion communicated with said probe portion and moving said probe portion to said reagent vessel or said sample supplying portion and said reaction vessel; and
a pump to which a pipe is connected, said pipe being communicated with the pump from said probe portion via said probe arm portion, and
wherein an enlarged area having a larger cross sectional area than a cross sectional area of said pipe in said probe arm portion is provided in said pipe positioned between said probe arm portion and said pump portion.

4. A chemical analysis apparatus comprising:
a reagent vessel provided with a reagent solution;
a sample vessel provided with a sample solution;
a reaction vessel to which said reagent and said sample are supplied;
a reagent supplying mechanism for supplying said reagent to said reaction vessel; and
a sample supplying mechanism for supplying said sample to said reaction vessel,
wherein at least one of said reagent supplying mechanism and said sample supplying mechanism comprises:
a probe portion for sucking and discharging the reagent;
a probe arm portion communicated with said probe portion and moving said probe portion to said reagent vessel or said sample vessel and said reaction vessel; and
a pump to which a pipe is connected, said pipe being communicated with the pump from said probe portion via said probe arm portion, and
wherein an elastic area structured by a material having a lower elastic modulus in tension than said probe and having a rigidity of elastic modulus in tension between 100 and 3000 kgf/cm² is provided in said pipe positioned between said probe arm portion and said pump portion.

5. A chemical analysis apparatus as claimed in claim 1, wherein an area having a large cross sectional area in said narrow area is provided closer to the pump than said narrow area.

6. A chemical analysis apparatus comprising:
a reagent vessel provided with a reagent solution;
a sample vessel provided with a sample solution;
a reaction vessel to which said reagent and said sample are supplied;
a reagent supplying mechanism for supplying said reagent to said reaction vessel; and
a sample supplying mechanism for supplying said sample to said reaction vessel,
wherein at least one of said reagent supplying mechanism and said sample supplying mechanism comprises:
a probe portion for sucking and discharging the solution;
a probe arm portion communicated with said probe portion and moving said probe portion to said reagent vessel or said sample vessel and said reaction vessel;
a first pump to which a pipe is connected, said pipe being communicated with the pump from said probe portion via said probe arm portion; and
a second pump communicated with said pipe in an upstream side of said probe arm portion via a branch portion, and
wherein said first pump has a higher discharge resolving power than said second pump, and said chemical analysis apparatus is controlled in such a manner as to supply a first flow rate of solution from said probe by driving said second pump and supply a second flow rate more than said first flow rate of solution by driving said first pump.

7. A chemical analysis apparatus comprising:
a reagent vessel provided with a reagent solution;
a sample vessel provided with a sample solution;
a reaction vessel to which said reagent and said sample are supplied;
a reagent supplying mechanism for supplying said reagent to said reaction vessel; and
a sample supplying mechanism for supplying said sample to said reaction vessel,
wherein at least one of said reagent supplying mechanism and said sample supplying mechanism comprises:
a probe portion for sucking and discharging the solution;
a probe arm portion communicated with said probe portion and moving said probe portion to said reagent vessel or said sample vessel and said reaction vessel;
a first pump to which a pipe is connected, said pipe being communicated with the pump from said probe portion via said probe arm portion; and
a second pump communicated with said pipe in an upstream side of said probe arm portion via a branch portion, and having a lower discharge resolving power than said first pump, and
wherein said chemical analysis apparatus is controlled in such a manner as to start supplying said solution from said probe by said first pump after starting supplying said solution from said probe by said second pump.
